(19) United States
(12) Patent Application Publication
(10) Pub. No.: US 2025/0117660 A1
(43) Pub. Date: Apr. 10, 2025

(54) GENETIC ALGORITHM FOR PRUNED MODEL GENERATION

(71) Applicant: Dell Products L.P., Round Rock, TX (US)

(72) Inventors: Vinicius Michel Gottin, Rio de Janeiro – RJ (BR); Paulo Abelha Ferreira, Rio de Janeiro – RJ (BR); Pablo Nascimento da Silva, Niterói – RJ (BR)

(21) Appl. No.: 18/484,346

(22) Filed: Oct. 10, 2023

(51) Int. Cl. G06N 3/082; G06N 3/086

(52) U.S. Cl. CPC G06N 3/082; G06N 3/086

(57) ABSTRACT

One method includes causing one or more edge nodes to generate and train an initial full candidate machine learning (ML) model, and the training of the initial full candidate ML models is performed only once at the one or more edge nodes, at a central node, applying a respective random prune mask to each of the initial full candidate ML models so as to generate a respective pruned model, and each of the pruned models includes an individual in an initial generation, computing a fitness score for each of the individuals based on a generalization loss and on a number of pruned parameters in the model, and when a halting condition is not met, performing a search-iteration process to create a next generation of individuals or, alternatively, when the halting condition is met, deploying a pruned model of a best scoring individual to one or more target edge nodes.

### FIELD OF THE INVENTION

Embodiments of the present invention generally relate to deployment of ML (machine learning) models in an edge environment. More particularly, at least some embodiments of the invention relate to systems, hardware, software, computer-readable media, and methods, for obtaining and deploying an ML model that is efficient and generalizes well to a deployment environment, while also preserving the privacy of data handled by the ML model at nodes in the deployment environment.

### BACKGROUND

An organization such as a business entity may have a need to deploy ML model(s) to edge nodes in an edge environment. A significant concern with such deployments is that of data privacy. That is, each node has access to a local dataset that must be kept private from the other nodes in the environment. Another concern is the possible lack of resources at the edge for running the ML model. Thus, the current environment presents some challenges, namely, how to obtain a model that is both efficient and generalizes well within a distributed edge domain, and how to do so in a privacy-preserving manner.

### BRIEF DESCRIPTION OF THE DRAWINGS

In order to describe the manner in which various advantages and features may be obtained, a more particular description of embodiments will be rendered by reference to specific embodiments thereof which are illustrated in the appended drawings. Understanding that these drawings depict only example embodiments and are not therefore to be considered to be limiting of the scope of this disclosure in any way, embodiments will be described and explained with additional specificity and detail through the use of the accompanying drawings.

FIG. 1 discloses aspects of an edge environment in which distinct nodes possibly have locally available data and heterogeneous computing capabilities.

FIG. 2 discloses aspects of a high-level overview of the generate-and-test pruned candidate model search, particularly, a process running inside a source node Eᵢ, the cloud/central node A, a generalization node Eₖ and a target node E_{z}.

FIG. 3 discloses an overview of a guided algorithm approach for pruned candidate model search—this approach may remove the ‘generate-and-test’ aspect and rather generates iteratively new generations of “individuals” at the central node.

FIG. 4 discloses full candidates a,b collected at the central node that each yield multiple pairs (θ, M) of model parameters θ and a pruning mask M—each pair is called an ‘individual’ I for the genetic algorithm search.

FIG. 5 discloses aspects of a pruned candidate model obtained from the individual I_{a,z} by applying the prune mask M_{z} over the full candidate parameters θₐ.

FIG. 6 discloses top-fitness individuals q and a random sampling r of individuals selected for creating next generation.

FIG. 7 discloses new individuals obtained via cross-over of selected individuals in gᵢ.

FIG. 8 discloses two individuals with different prune masks for the same full candidate model yield two new individuals via cross-over.

FIG. 9 discloses mutation applied over all cross-over individuals, comprising additional pruning by flipping elements of the prune masks to zero with probability p.

FIG. 10 discloses aspects of a computing entity operable to perform any of the disclosed methods, processes, and operations.

### DETAILED DESCRIPTION OF SOME EXAMPLE EMBODIMENTS

Embodiments of the present invention generally relate to deployment of ML (machine learning) models in an edge environment. More particularly, at least some embodiments of the invention relate to systems, hardware, software, computer-readable media, and methods, for obtaining and deploying an ML model that is efficient and generalizes well to a deployment environment, while also preserving the privacy of data handled by the ML model at nodes in the deployment environment.

In general, an embodiment may comprise a method or scheme that requires only a set of source nodes to generate a single set of initial full, that is, unpruned, candidate models, generated only once. At a central node, such as may be hosted in a cloud/core environment, an embodiment may perform a genetic algorithm search, following the “lottery ticket” hypothesis, for an adequate pruning of one of the initial full candidate models. Because, in an embodiment, the training at the source nodes is performed only once, an embodiment may perform, and/or enable the performance of, the training with full-scale datasets, thus obviating the requirement for a preexisting distilled dataset.

In more detail, a method according to one embodiment may comprise the following operations: [1] a set of source nodes Eₛ generates a set of full candidates, based on a known architecture and a distribution function p(θ) for sampling initial weights of the models; [2] the full candidate model is trained with a locally available dataset, which may be a distilled dataset generated for the same family of models as defined by the known architecture and p(θ); [3] the full candidate model is communicated to a central node; [4] and [5], define go, the initial generation of individuals that will be the subject of the genetic algorithm; [6] compute a fitness score for each individual in initial generation; [7] orchestration of which individual generalization nodes are used to evaluate which models, and orchestration of auxiliary structures to track the average loss L̅ of each model; [8] performing a loss evaluation of each individual at a generalization node; [9] communicating an outcome of the loss evaluation(s) from the generalization node(s) to the central node—note that [7], [8] and [9] may be invoked in response to [6], and [13], discussed below; checking a halting condition and if the halting condition is met, deploying the winning candidate to the target nodes, otherwise, proceeding to [11]; [11] performing a search-iteration process, such as in the form of a genetic algorithm for generating increasingly better (more accurate, general, and smaller) individuals at each iteration; [12] updating index i so that it is now denoted gᵢ, for the evaluation and the next loop; closing the search process loop by evaluating the individuals in the new generation gᵢ₊₁—as in [6], the cloud/core central node A evaluates the current individuals, leveraging when necessary the generalization nodes to compute loss scores for the pruned models obtained from those individuals.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an ML model may be obtained that is relatively small, and generalizes well to a distributed edge domain. In an embodiment, an ML model may be obtained and used in a way that maintains the privacy of data at a node where the ML model is deployed. Various other advantages of one or more example embodiments will be apparent from this disclosure.

### A. Overview of an Embodiment

The following is an overview of an example embodiment. This discussion is not intended to limit the scope of the invention in any way.

In general, an embodiment may consider the deployment of ML model(s), which may also be referred to herein simply as a ‘model’ or ‘models,’ to edge nodes in an edge environment. As noted earlier, a present concern is that of data privacy, that is, each node has access to a local dataset that must be kept private from the other nodes. Another concern is possible lack of resources at the edge. Thus, an embodiment may comprise the creation and/or use of a model that achieves high accuracy and generalizes well to the domain, while ensuring data privacy. For efficiency purposes, and due to resource constraints, this model may be as small as possible. The model can then be quickly deployed to a new edge node in an edge environment, even before it has obtained enough local samples or sufficient time has elapsed for the bootstrap training of a local model.

In order to deal with the challenges of obtaining a model that is both efficient and generalizes well within a distributed edge domain, and doing so in a privacy-preserving manner, an embodiment may employ a “generate and test” approach (an example of which is disclosed in U.S. patent application Ser. No. 18/179,472, filed on Mar. 7, 2023, titled “EFFICIENT PARALLEL SEARCH FOR PRUNED MODEL IN EDGE ENVIRONMENTS” (“Efficient Parallel Search”), which is incorporated herein in its entirety by this reference) which may leverage other edge nodes to obtain a pruned model which may be relatively small, efficient to communicate between nodes and efficient to run, and that is general to the domain and thus most likely to be applicable at one or more target nodes.

An embodiment may comprise a scheme with a genetic algorithm for the pruned model generation and deployment. This genetic algorithm may be used to obtain a model that achieves high accuracy and generalizes well to the domain, while ensuring data privacy. For efficiency purposes, and due to resource constraints, this model may be relatively small, and may be as small as possible. The model may then be quickly deployed to a new edge node in an edge environment, even before it has obtained enough local samples or sufficient time has elapsed for the bootstrap training of a local model. The resulting, small, model may be easily deployed to edge nodes that are too resource constrained to host and run larger models.

### B. Aspects of an Example Embodiment

An embodiment may comprise various useful features and aspects. In this regard, an embodiment may fill a gap in technology by providing an approach for the parallel search for a pruned model in edge environments leveraging distilled datasets. One example embodiment may comprise a genetic algorithm formulation for the candidate generation that may perform various functions. For example, the genetic algorithm may be used in place of a generate-and-test approach, which requires multiple generations of candidates at the source nodes, for a genetic algorithm approach that requires only a single initial candidate generation. As another example, a genetic algorithm according to an embodiment may define and implement a fitness scoring function that considers both the accuracy and generalization of the candidate models as well as their size. In another example, a genetic algorithm according to an embodiment may generate new candidates by a specialized cross-over approach over selected candidates, based on parameters used for the original candidate generation and pruning. Finally, a genetic algorithm according to an embodiment may prune the candidate models as the generations progress by virtue of a customized ‘mutation’ process, which may tend to favor the fitness scoring.

### C. Context for an Example Embodiment

### C.1 Lottery Ticket Neural Networks

The lottery ticket hypothesis (disclosed in J. Frankle and M. Carbin, “THE LOTTERY TICKET HYPOTHESIS: FINDING SPARSE, TRAINABLE NEURAL NETWORKS,” in International Conference on Learning Representations, New Orleans, 2019 (“Frankle”)—which is incorporated herein in its entirety by this reference) is the hypothesis that it is possible to find a much sparser network inside another one that when trained can match the test accuracy of the original, denser, one. More formally (from Frankle): “The Lottery Ticket Hypothesis. A randomly-initialized, dense neural network contains a subnetwork that is initialized such that—when trained in isolation—it can match the test accuracy of the original network after training for at most the same number of iterations.” The overall idea of the lottery ticket method in Frankle is to uncover this sparser network by performing several rounds of training, followed by pruning. The pruning has a decay function, so there is ever less pruning as the method proceeds through the rounds of training. The sparser network found is sometimes referred to as the ‘winning ticket.’

It is noted that the sparser network may be found through the lottery ticket method, but may still have to be trained from scratch to obtain a well performing network. The point, however, being that this network requires the same amount of training, but can perform inference at a much lower cost due to high sparsity.

### C.2 Dataset Distillation

Dataset distillation is a recent research area (aspects are disclosed in T. Wang, J.-Y. Zhu, A. Torralba and A. A. Efros, “Dataset Distillation,” in arXiv: 1811.10959 [cs.LG], 2019 (“Wang”)—which is incorporated herein in its entirety by this reference) in which techniques are being developed to obtain a much smaller dataset that is still able to train an ML model to reasonable accuracy. One aim of dataset distillation may be to try to find an answer to the following question: What would be a small synthetic dataset that when used to train a model, would yield low error?

Thus, an embodiment may not be concerned merely with a small sample of a dataset, nor necessarily interested in a compression of the full dataset. Rather, an embodiment may comprise an approach for building a sketch, that is, a distilled dataset, of the data to approximate a function, such as may be an element of, and implemented by, an ML.

In an embodiment, such a distilled dataset may be obtained through a double optimization process, beginning with a synthetic random dataset, such as a set of white noise images for example, and the optimizing a model with a known, real, dataset and then calculate a loss on the current synthetic dataset. Then, an optimization may be performed with respect to the synthetic dataset on this calculated loss. An embodiment may sample many different models in this optimization process to obtain a distilled dataset that is robust to in-distribution changes to a family of models.

### C.3 Environment Definitions

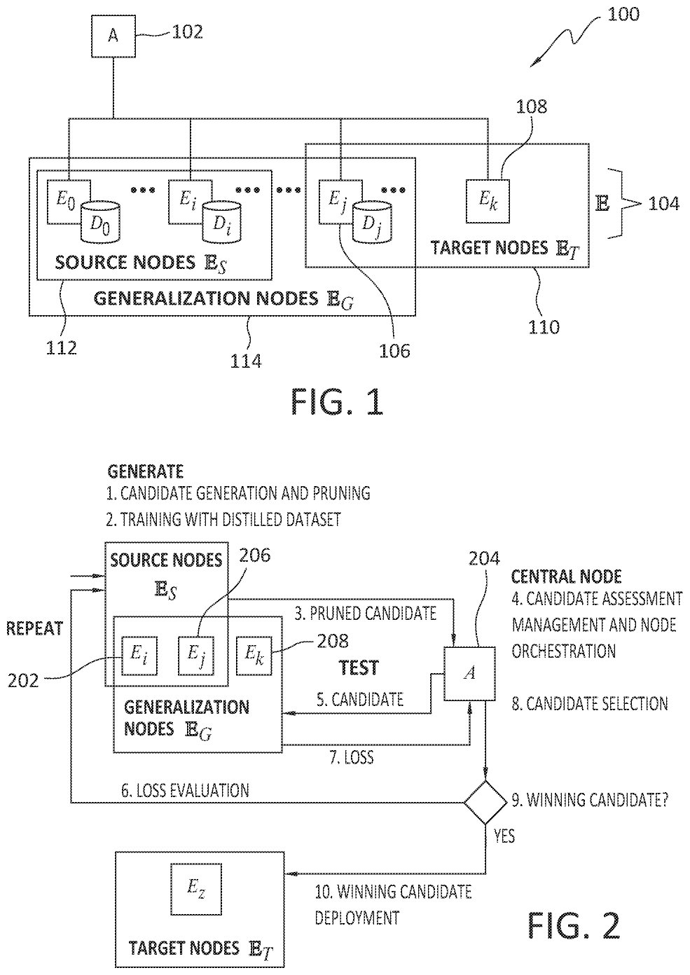

With reference to the example environment 100 in FIG. 1, an embodiment may be implemented in an environment with a central node 102, which may be located at and/or comprise a core or cloud location, and multiple, and possibly numerous, edge nodes 104 [symbol] ={E₀, E₁, . . . }, wherein local datasets D₀,D₁, . . . are collected, respectively. One of these edge nodes 104, or another suitable computational infrastructure, such as a robust near-edge infrastructure, may be defined to be the central node 102. Thus, FIG. 1 discloses an example environment 100, such as an edge environment for example, in which distinct nodes may have locally available data and heterogeneous computing capabilities.

In FIG. 1 there are disclosed edge nodes with heterogeneous computing capabilities, where the node 106 Eⱼ is highlighted as a node with restricted computational resources. A node 108 Eₖ is indicated as a node without a local dataset. In this example then, both of the nodes 106 and 108 are therefore incapable of training a local ML model. These nodes may be referred to as the target nodes 110 [symbol] _{T}⊂ [symbol] .

An embodiment may provide target nodes, such as the target nodes 110, with a ‘winning lottery ticket’ model, possibly trained by another edge node 104 and validated by multiple other edge nodes, that may achieve good accuracy and generalization in the domain. Notice that although the ML model may be trained with the data of another edge node, those data are not communicated at all, thus ensuring data privacy.

With continued reference to the example of FIG. 1, source nodes 112 may be defined [symbol] _{S}⊂ [symbol] . The source nodes [symbol] _{S} are the nodes with both sufficient computational resources and local data, capable of training an ML model. These are the nodes that may originate new pruned model candidates.

Finally, a set of generalization nodes 114 [symbol] _{G}⊂ [symbol] defined in FIG. 1. These generalization nodes 114 may comprise all the nodes with local data and sufficient computational resources to perform a single evaluation of the model on those data. Hence, an embodiment may assume, for simplicity at least, that [symbol] _{S}⊂ [symbol] _{G}. These generalization nodes 114 are the nodes that may be used for a distributed generalization validation of the pruned model candidates. As indicated in FIG. 1, a set of generalization nodes 114 may comprise both one or more target nodes 108, and one or more source nodes 112.

### C.4 Efficient Pruned Model Generation

In Efficient Parallel Search, a large number of edge nodes is exploited and an available distilled dataset to effectively parallelize a generate-and-test search process for a ‘winning’ lottery ticket model—that is, a very small model that achieves comparable accuracy to the accuracy obtained with a much larger baseline model. In that approach:
a set of “source nodes” with both sufficient data and resources are used to train candidate models which are pruned and evaluated, and if deemed sufficiently good are sent to the central node;
the training leverages a distilled dataset, for efficiency purposes;
the central node orchestrates the training and pruning of these candidate models by the source nodes and also tests them at generalization nodes, which have some data and, potentially, very little resources-enough to run inference but possibly not enough to train models; and
the central node continuously evaluates the candidates (generated and tested) and discards those that are un-generalizing. Upon determining a good-enough best model, it is deployed to the target nodes.

Although a distilled dataset allows the training of models at the edge nodes with efficiency, there's still a whole lot of computational costs to be dealt with (the edge nodes need to generate and train multiple models). Furthermore, the obtaining of a distilled dataset may be cost-intensive and difficult, depending on the scenario. That approach is represented in FIG. 2 which discloses a high-level overview of the generate-and-test pruned candidate model search. Particularly, FIG. 2 discloses the process running inside a source node 202 Eᵢ, the cloud/central node 204 A, a generalization node 206 Eⱼ and a target node 208 Eₖ.

The Efficient Parallel Search approach starts with the candidate generation and works in a repeated loop. It ensures data privacy as each node only uses its local data for validation, that is, loss computation, of the candidate pruned models, and the central node 204 performs the orchestration of which candidate models are tested at which generalization nodes such as the generalization node 206. The details of the operations 1 through 10 disclosed in FIG. 2 are set forth in the ‘Appendix’ hereto, which is incorporated herein in its entirety by this reference. To facilitate a better understanding of one example embodiment, some concepts regarding the framework disclosed in the Appendix are:
it requires a distilled dataset to enable the fast generation and training of pruned candidates at source edge nodes;
it introduces a mechanism for monitoring and controlling the dispatch of pruned models for validation and evaluation at generalization nodes; and
it applies a parallel ‘generate and test’ scheme in which the source nodes are continuously generating new pruned model candidates, trained over a distilled dataset, and the central node orchestrates the evaluation of those pruned model candidates at generalization nodes.

### D. Pruned Candidate Model Search

### D.1 Search Process

One example embodiment comprises a framework for generating a pruned model. Note that, by way of contrast with a pruned model, a full model may a model for which none of the parameters, or weights of a neural network of the model, have been pruned. In an embodiment, a prune mask, or pruning mask, may be used to reduce the number of parameters employed in a model, so as to possibly reduce the size of the model, and thus require fewer resources to run, than a full model. If the pruned parameters are well selected, the pruned model may be smaller than the full model, but still provide results comparable to those obtainable with the full model. In general, the pruning mask may thus determine which weights or parameters of the full model will be retained, and which will be pruned. In the mask, a weight to be retained may be denoted with a ‘1’ and a weight to be pruned may be denoted with a ‘0.’ In general, the mask may be applied to the full model, and the model may then be run with the pruned set of parameters or weights. A loss, which may reflect model performance, may then be determined for the pruned model, and the loss may be returned as an output. If the loss is lower than an established threshold, the pruning process may be ended.

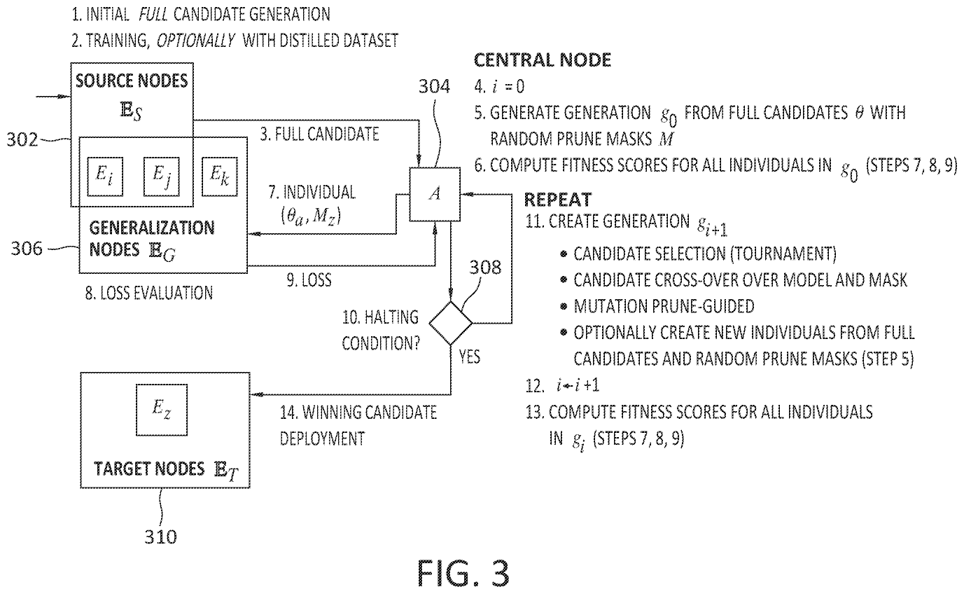

With reference now to FIG. 3, there is disclosed a framework for generating a pruned model. As well, FIG. 3 identifies some of the distinctions between the example embodiment and the approach disclosed in Efficient Parallel Search. Particularly, FIG. 3 discloses an overview of the guided algorithm approach for pruned candidate model search, according to one example embodiment. This approach removes the ‘generate-and-test’ aspect and, instead, iteratively generates new generations of “individuals” at a central node. That is, and in contrast with the Efficient Parallel Search approach, this embodiment changes the framework from a ‘generate and test’ approach, at the source nodes, to a guided search, performed at the central node/cloud, in a genetic algorithm fashion. Other aspects of the example embodiment disclosed in FIG. 3 include, but are not limited to, the following:
the approach starts with full, non-pruned, models at the source nodes, and lets the genetic algorithm prune the models;
no training of the models needs to take place after the initial full candidate training—rather, the iterative pruning is adequate to generate an accurate and general model, following the lottery ticket hypothesis discussed earlier herein;
no explicit architecture search is required to be performed-rather, the search process in this example embodiment prunes models from a known ‘family’ of models, with known architecture, that are known to achieve reasonably high accuracy in its full version.

### D.2 Initialization

### D.2.1 Source Node Full Candidate Generation

Referring again to the example of FIG. 3, in Step 1, a set of source nodes 302 [symbol] _{S} generates a set of full candidates, based on a known architecture and a distribution function p(θ) for sampling initial weights of the models. The models are “full” in the sense that they are not pruned. In contrast with other approaches such as the Efficient Parallel Search, an approach according to one example embodiment starts with these full-size candidate models and lets the genetic algorithm approach iteratively prune the models over the incremental generations. Note that as used herein, a ‘Step’ and ‘step’ are not intended to invoke or imply a ‘step+function’ approach. An embodiment denotes the set of parameters θₐ={p₀, p₁, p₂, . . . , p_{|θ|}} of each full candidate a. Initially, these may be all randomized values, as is the case in some neural network approaches.

In Step 2, of FIG. 3, the full candidate model is trained with a locally available dataset, which may be a distilled dataset generated for the same family of models as defined by the known architecture and p(θ)—and communicated to a central node 304 in Step 3.

In an embodiment, the training of candidates at the source nodes 302 may be performed only once, instead of repeatedly. Thus, an embodiment may be able to perform the, much more expensive, training with local real data, instead of using a distilled dataset, which May be less expensive to use than the local real data, but not readily obtainable. The source nodes 302 may apply a straightforward preemptive filtering of full models that do not achieve a minimum required accuracy in its own test dataset. The resulting candidates a, b, . . . , each defined by a set of parameters θₐ, θ_{b}, . . . that are now fitted after training, are then collected at the central node 304.

### D.2.2 Central Node Initial Generation

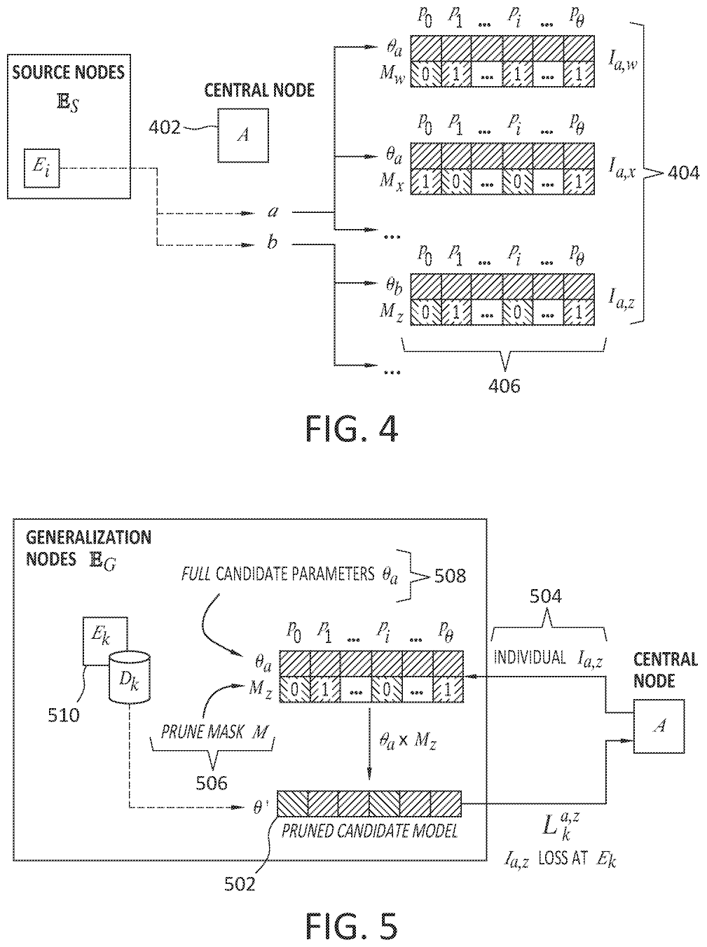

Referring again to FIG. 3, in Step 4 and Step 5, an embodiment defines go, the initial generation of individuals that will be the subject of the genetic algorithm. An individual I_{a,z} is defined by a tuple (θₐ, M_{z}) in which θₐ is a trained full candidate—that is, the model parameters corresponding to the full candidate ‘a’ and M_{z} is a Boolean “Prune Mask,” with one value for each parameter in θ indicating whether that weight is ‘pruned,’ that is, zeroed. This is disclosed in FIG. 4.

In particular, FIG. 4 discloses full candidates a, b collected at the central node 402 (see also, central node 304 in FIG. 3) that each yield multiple pairs 404 of parameters and pruning masks. Each of these pairs is referred to as an ‘individual’ for the genetic algorithm search. In FIG. 4, there is represented the individuals generated by creating random pruning masks for two full candidate models a, b—for example, the individual I_{a,z} 406 corresponds to the full candidate parameters θₐ and the pruning mask M_{z}In real implementations, the number of candidates and individuals may be much larger. The initial generation may comprise n individuals, wherein multiple individuals may originate from the same full candidate, with different randomly initialized prune masks for each of the individuals.

### D.3 Fitness Score Computation

In Step 6 of FIG. 3, an embodiment computes a fitness score for each individual in initial generation. Later, in the main loop of the genetic algorithm, the same technical description applies to Step 13. It is noted that relatively small variations in the models, such as may result from a pruning process, may generate variations in the quality of the results generated by those models. An embodiment may account for this in a computation of the fitness of the individual models. An embodiment may define the fitness-score of individuals in such a way as to penalize those models with worse generalization, that is, worse aggregate losses obtained at the generalization nodes 306, and also to penalize larger models.

Recall that each individual model is given by a full candidate model weight θₐ and a prune mask M. A measure of the extent to which a model has been, or will be, pruned, is directly given by ΣM, the number of masked parameters in M.

The fitness score may be computed for each individual model, weighing the loss values and the amount of masked weights in the respective masks of the models. That is, the fitness is higher for candidates that are more general, or have a lower loss observed in the generalization nodes 306, and smaller, or have a relatively larger number of masked parameters. One embodiment for the fitness score F of an individual (θₐ, M) is given by:

$$F = \overline{L} \times \frac{\sum M}{\vert θ \vert}$$

### Where:

L̅ is the aggregate loss obtained for the candidate c at the generalization nodes. We discuss this in the next section; and
ΣM equals the number of masked parameters in the candidate, and |θ| is the number of parameters in the full models (and, therefore, in the mask).

It is noted that other kinds of specific fitness functions considering these aspects may apply.

### D.4 Model Evaluation at the Generalization Nodes

With continued reference to the example embodiment disclosed in FIG. 3, the Steps 7, 8 and 9 may be invoked in response to Step 6, and Step 13. For determining the accuracy and generalization of the individuals, the central node 304 leverages the generalization nodes [symbol] G. This may require some level of orchestration and tracking of which edge nodes receive which models. One embodiment may assume a similar orchestration and auxiliary structures as those in Efficient Parallel Search. Other mechanisms for orchestration and tracking may apply, however. Thus, Steps 7, 8, and 9 may be similar to those as described in the Appendix—the orchestration of which generalization nodes are used to evaluate which models, as well as auxiliary structures to track the average loss L̅ of each model, as described in 1.1.3 of the Appendix, and the loss evaluation is described in 1.1.4 of the Appendix.

In contrast with the approach taken in the Appendix however, an embodiment may employ a model for evaluation that comprises both the weights θₐ and the prune mask M. The generalization node 306 may apply the prune mask over the weights before a loss evaluation of the ML model is performed. This is a simple element-wise multiplication to obtain the concrete weights to be considered by the model in the loss evaluation: θ′=θₐ×M_{z}. This is represented in FIG. 5, which discloses that a pruned candidate model 502 may be obtained from the individual I_{a,z} 504 by applying the prune mask M_{z} 506 over the full candidate parameters θₐ 508.

It is noted that the communication overhead may be greatly diminished if the generalization node 510 (see also 306 of FIG. 3) already stores the original pruned model corresponding to the weights θₐ. This is possible:
When the generalization node Eₖ 510 is also the source node that originated that model a, recalling that there is overlap between source and generalization nodes (see FIG. 3, for example); and
the generalization node has a local copy of the full model parameters θₐ in disk and/or memory.

In that case, the generalization node 510 simply applies the mask 506 over the local copy of the full candidate model parameters 508 and does not require the weights to be communicated. Further, additional orchestration is possible such that:
the generalization nodes may manage local copies of the full candidates; and
additional orchestration still at the central node so that multiple individuals (θₐ, M_{z}), (θₐ, M_{w}), (θₐ, M_{y}), . . . all relative to the same full model a are sent to the same generalization nodes for evaluation.

### D.5 Genetic Algorithm Iteration

With continued reference to the example embodiment disclosed in FIG. 3, Step 11 comprises the search-iteration, in the form of a genetic algorithm for generating increasingly better, that is, more accurate, general, and smaller, individual models at each iteration. The central node 304 generates a new generation of individuals using specific selection, cross-over and mutation processes. The following subsections describe some of the details of this approach. The immediately following subsection describes how a generation gᵢ₊₁ may be generated based on the previous generation gᵢ.

### D.5.1 Selection

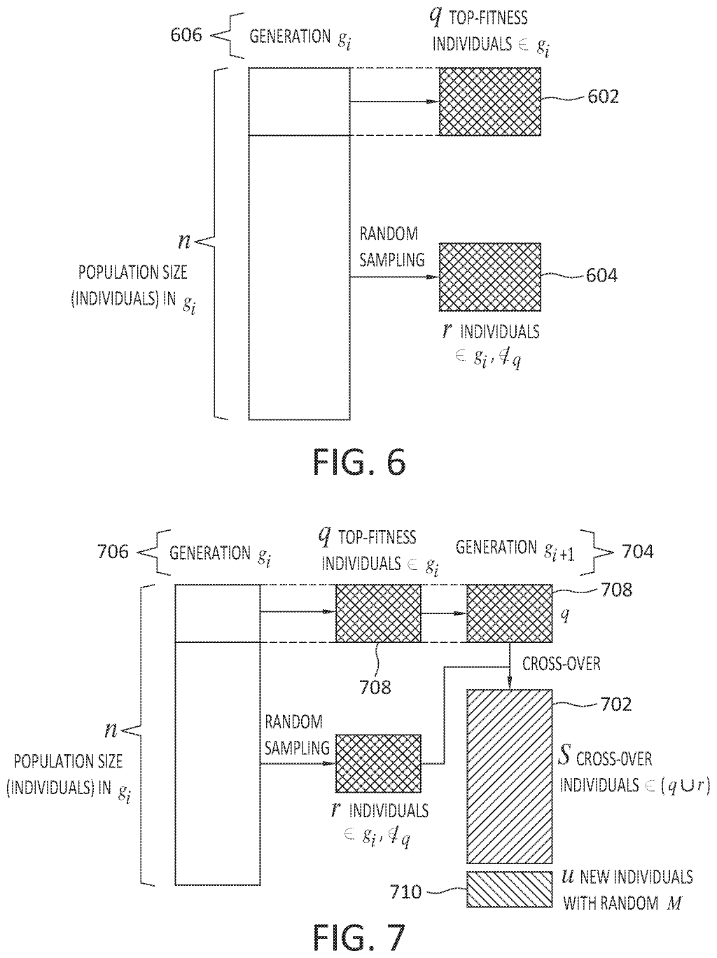

The purpose of the selection step is to ensure that individuals in the current generation with a higher fitness are sufficiently present in the next generation, while also allowing some factor of randomness. The randomness may be important to allow coverage of the possible search-space. That is, in the absence of randomness, a greedy best-fitness approach tends to converge faster, but at the cost of worse, that is, poorer performing, global solutions. FIG. 6 discloses an approach, in one example embodiment, for the selection of the individuals for the next generation.

Particularly, FIG. 1 discloses a group of top-fitness individuals q 602 and a random sampling r 604 of individuals selected for creating a next generation. An embodiment comprises a selection process as follows. First, sort the individuals in generation gᵢ 606 by their respective fitness and select the top-fitness individuals q 602 for the next generation. This embodiment may also obtain a random selection of r other individuals. These other individuals should not be selected from q, so as to ensure variability. Any random sampling process may be employed.

Any appropriate, fitness-based, process for selection is applicable. Notably, the fitness of the individuals are those computed in Step 6, and in later iterations of the loop in Step 13, based on the assessment of the pruned models at the generalization nodes.

### D.5.2 Cross-Over Candidate Generation

An embodiment may then proceed to generate s new individuals 702 for generation gᵢ₊₁ 704 from those selected from gᵢ 706. This is disclosed in FIG. 7, which shows new individuals obtained via cross-over of selected individuals in gᵢ 706. Note that the top-fitness individuals q 708 are not mutated, in the interest of preserving the stability of the model.

Particularly, in the cross-over of individuals (q∪r) 702 an embodiment performs a mix of the prune masks, but this embodiment only crosses-over those individuals originating from the same original full candidates. Note that, in an embodiment, u new individuals 710 may or may not be added to generation gᵢ₊₁ 704.

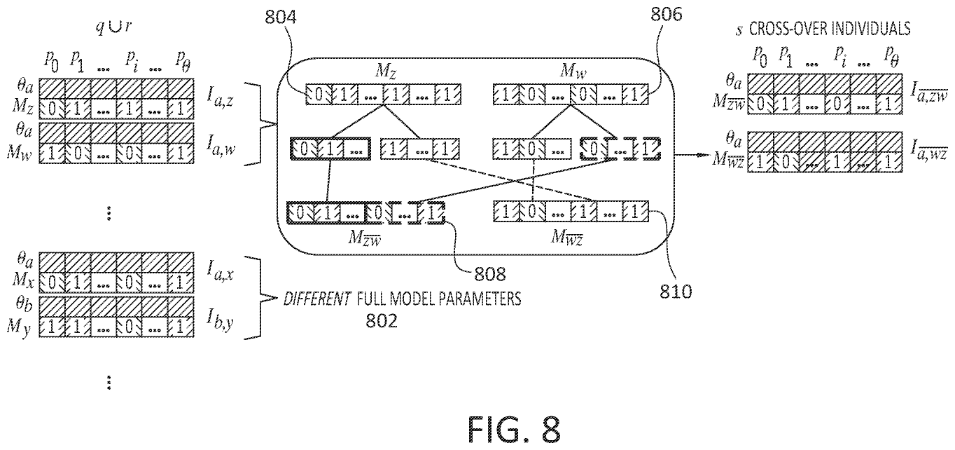

An example of this cross-over approach is disclosed in FIG. 8, in which individuals I_{a,x} and I_{b,y}, collectively denoted at 802, originating from the full candidate models a and b, respectively—are not crossed-over. In particular, FIG. 2 discloses two individuals with different prune masks for the same full candidate model yield two new individuals via cross-over.

In the example embodiment of FIG. 8, the cross-over mechanism comprises taking the first half of the prune mask M_{z} 804 and the second part of mask M_{w} 806, when crossing individuals I_{a,z} and I_{a,w} 802, to generate a new mask M_{z̅w̅} 808 for a new individual I_{a,z̅w̅}. Conversely, a new mask M_{w̅z̅} 810 is created with the first part of M_{z} 804 and the second part of M_{w} 806.

The aforementioned cross-over mechanism is provided by way of example, and alternative approaches may be employed. One such alternative may involve taking the even-indexed positions and odd-indexed positions of the masks, instead of using first-halves and second-halves, as in the example of FIG. 8. In still other approaches, the proportions of the masks used to create new masks do not need to be equal, that is, half and half, but may instead be implemented with variable proportions from each ‘parent’ individual.

In general, an embodiment of a cross-over process and mechanism may comprise the following characteristics:
only individuals regarding the same parameters—and therefore originating from the same full candidate—should be crossed-over. It is not necessarily intended that the genetic algorithm process should operate as a substitute for the training of neural networks—all the training necessary is performed when generating the full candidate models in the source nodes;
the cross-over process should consider the prune masks of multiple individuals in the population—this may be typical in genetic algorithm approaches, and comprises a large part of the ‘exploration’ in the search space, along with the mutation, as discussed elsewhere herein; and
the cross-over process must not consider the parameters of the models—the lottery ticket hypothesis suggests that a pruned version of each original full candidate model exists that is both accurate and very small—this approach does not compare with training or architecture search, rather, it searches the possible pruning “space” to find a first ‘winning’ lottery ticket model.

Some additional considerations may apply to the aforementioned cross-over process and mechanism. Namely, in the selection process, a situation can arise in which only a few, or a single one, individual from a specific full candidate a is in the pool. With a restriction of only crossing-over individuals based on same set of model parameters θₐ, those individuals, or single individual, would be hard, or impossible, to combine with others via cross-over. Hence, an embodiment may include an optional mechanism to repopulate generation gᵢ₊₁ with new individuals, generated from the full candidate models and random masks, as in Step 5. This is depicted in FIG. 7, and described in further detail below. Finally, the determination of which selected individuals are crossed-over may be arbitrary, and take any form typical in the genetic algorithm literature. A most straightforward embodiment is to generate s crossed-over individuals for populate generation gᵢ₊₁ with all possible cross-overs from the selected individuals q∪r.

### D.5.3 Prune-Guided Mutation

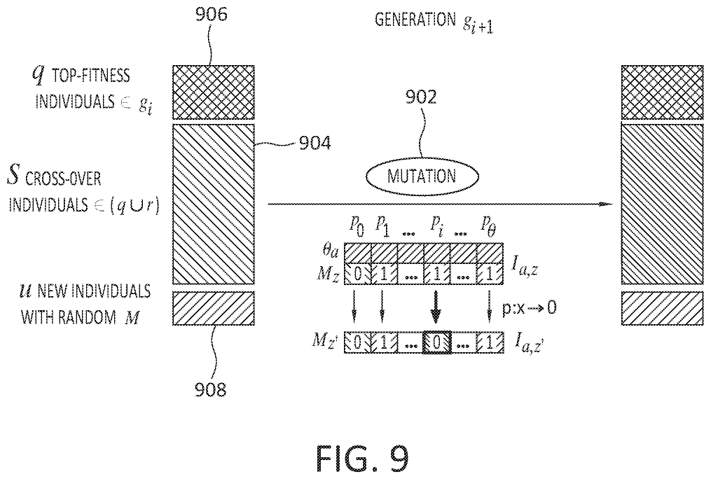

Another characteristic of a genetic algorithm approach according to one embodiment is the use of a prune-guided mutation process. One example mutation process may be as follows. An embodiment may establish a probability p, which may be very small, for ‘flipping’ each position in the pruning mask to zero. This is depicted in FIG. 9, which discloses a mutation 902 applied over all cross-over individuals 904, comprising additional pruning by ‘flipping’ elements of the prune masks to zero with probability p. By applying the mutation 902 that adds pruning to an individual, tentatively favorable mutations may be obtained, as the added pruning improves one of the factors in the computation of the fitness of the individual. The evaluation of the individual also comprises the loss evaluation at the generalization nodes, and the pruning (mutations) that do not help keep the accuracy of the model should be selected out for future generations.

In the example embodiment of FIG. 9, the mutation process 902 is not applied over the top-fitness individuals q, 906 allowing them to be replicated from generation gᵢ to gᵢ₊₁. Allowing mutation over q could speed up the pruning of the iterative generations, but may unduly ‘eliminate’ from the population a promising individual for future cross-over. Further, the mutation process 902 is not applied over new individuals u 908, as discussed hereafter.

### D.5.4 Re-Populate Generation

An embodiment may create new individuals from full candidates and random prune masks. This is similar to the process performed in Step 5. This step may be important in a few situations:
as described above, to allow a same full candidate to have a reasonable number of individuals spawned from it in the population; and
to increase population size—assuming that generation gᵢ is of size n, an embodiment may opt to include new individuals u so that |q∪s∪u| is similar to n.

In an embodiment, tracking the amount of resources available at the cloud/core central node A, and also at the available generalization nodes [symbol] _{G}, may allow dynamically determining the desired population size for each generation. In that case, both the cross-over and the re-population steps may be informed by that target number of individuals, with this re-population step ‘filling in the gaps’ after the selection and cross-over.

It is noted that in an embodiment, creating new individuals from scratch is to partially ‘restart’ the search process, hence, this may be additionally important to obtain better, that is, more extensively pruned, ‘winning’ candidates overall at the end, as the expanded search would allow exploring multiple local minima, although at the expense of possibly many more iterations/generations. In order to moderate this ‘resetting’ aspect, the new individuals created in this step may have pruned masks that are more aggressively pruned. That is, the random function that generates the mask M_{z} for a new individual I_{a,z} from the original full candidate θₐ may be adjusted, from that of Step 5, so as to yield more ‘1’ values than ‘0’ values. It is for this reason, that an embodiment may not need to perform mutation over the new spawned individuals, rather, they are created with random masks, so the additional, random, pruning of the mutation can be applied a priori over these new individuals.

### D.5.5 Fitness Score Computation for the New Generation

An embodiment may close the search process loop in Step 13 (see FIG. 3), by evaluating the individuals in the new generation, updating index i so that it is now denoted gᵢ, for this evaluation and the next loop. As in Step 6, the cloud/core central node A 304 evaluates the current individuals, leveraging, when necessary, the generalization nodes 306 to compute loss scores for the pruned models obtained from those individuals.

### D.6 Halting Condition and Model Deployment

The lottery ticket hypothesis states that a pruned version of a full-size model will achieve comparable accuracy-even being much smaller. Thus, an embodiment may comprise the use of a halting condition check 308 (see FIG. 3) that reflects this. An individual has been generated that both:
achieves reasonable accuracy; and
with sufficient pruning.

Both criteria are present in the fitness score computation, as discussed earlier. Hence, in a most straightforward approach, an embodiment may employ a minimum fitness score threshold, and halt the genetic algorithm search when a candidate meets that fitness score threshold. This halting based on fitness is optional, however, as the search process may be allowed to continue to find other local minima.

A halting condition that may be present is that of stopping the process when m generations have been created without an improvement in best-fitness, that is, the fitness of the best-scoring individual. Typically a threshold of minimum acceptable improvement e may be determined, so that the creation of repeated generations without at least that improvement are taken as a signal to stop the genetic algorithm process. When stopping, an embodiment may obtain a pruned model from the best-scoring individual I_{a,z} in the current generation gᵢ. This is done by applying the pruned mask M_{z} over the model parameters θₐ, in similar fashion to that described earlier, and disclosed in FIG. 5.

The deployment of the ‘winning’ pruned candidate to the target node 310 models may follow any typical model deployment approach. After deployment, the model can be used for inferencing at the target node 310 and for general decision-making. Notice that this allows the target node 310 to obtain a model that is both small and accurate, as a result of the guided search performed by one embodiment.

### E. Example Methods

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising: in an environment comprising edge nodes and a central node configured to communication with the edge nodes, performing operations comprising: causing one or more of the edge nodes to generate and train an initial full candidate machine learning (ML) model, and the training of the initial full candidate ML models is performed only once at the one or more edge nodes; at the central node, applying a respective random prune mask to each of the initial full candidate ML models so as to generate a respective pruned model, and each of the pruned models comprises an individual in an initial generation; computing a fitness score for each of the individuals based on a generalization loss and on a number of pruned parameters in the model; and when a halting condition is not met, performing a search-iteration process to create a next generation of individuals or, alternatively, when the halting condition is met, deploying a pruned model of a best scoring individual to one or more target edge nodes.

Embodiment 2. The method as recited in any preceding embodiment, wherein the computing of a fitness score comprises: transmitting each of the individuals to a respective one of the edge nodes; causing each of the edge nodes to perform a loss evaluation of the individual received by that edge node; and receiving the loss associated to the individual at the central node.

Embodiment 3. The method as recited in embodiment 2, additionally comprising orchestration and tracking of which edge nodes receive which individuals for loss evaluation.

Embodiment 4. The method as recited in any preceding embodiment, wherein the training at each edge node is performed with real data that is local to that edge node.

Embodiment 5. The method as recited in any preceding embodiment, wherein the training is performed without any exchange of local data between the edge nodes.

Embodiment 6. The method as recited in any preceding embodiment, wherein the search-iteration process selects top fitness individuals and a random sample of individuals for inclusion in the next generation.

Embodiment 7. The method as recited in embodiment 6, wherein the top fitness individuals are identified according to their respective fitness scores.

Embodiment 8. The method as recited in any preceding embodiment, wherein the search-iteration process comprises generating new individuals for the next generation.

Embodiment 9. The method as recited in embodiment 8, wherein the new individuals are generated based on the individuals in the initial generation.

Embodiment 10. The method as recited in embodiment 8, wherein the new individuals are generated using new prune masks that include portions of the random prune masks that were used to generate the individuals in the initial generation.

Embodiment 11. The method as recited in any preceding embodiment, wherein the halting condition is met when ‘m’ generations of individuals have been generated without an improvement in best fitness of a best scoring individual.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

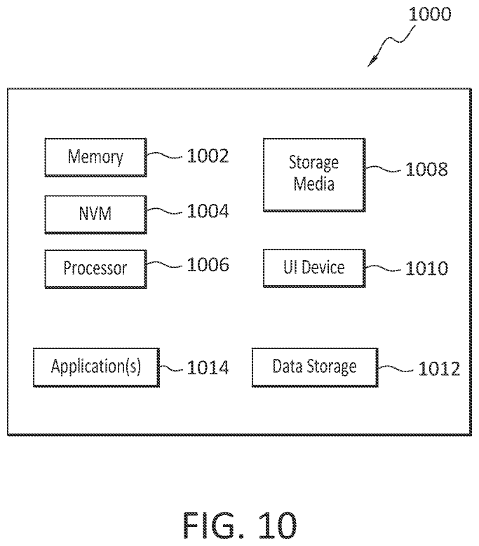

With reference briefly now to FIG. 10, any one or more of the entities disclosed, or implied, by FIGS. 1-9, and the Figures of the Appendix, and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
in an environment comprising edge nodes and a central node configured to communication with the edge nodes, performing operations comprising:
causing one or more of the edge nodes to generate and train an initial full candidate machine learning (ML) model, and the training of the initial full candidate ML models is performed only once at the one or more edge nodes;
at the central node, applying a respective random prune mask to each of the initial full candidate ML models so as to generate a respective pruned model, and each of the pruned models comprises an individual in an initial generation;
computing a fitness score for each of the individuals based on a generalization loss and on a number of pruned parameters in the model; and
when a halting condition is not met, performing a search-iteration process to create a next generation of individuals or, alternatively, when the halting condition is met, deploying a pruned model of a best scoring individual to one or more target edge nodes.

2. The method as recited in claim 1, wherein the computing of a fitness score comprises:
transmitting each of the individuals to a respective one of the edge nodes;
causing each of the edge nodes to perform a loss evaluation of the individual received by that edge node; and
receiving the loss associated to the individual at the central node.

3. The method as recited in claim 2, additionally comprising orchestration and tracking of which edge nodes receive which individuals for loss evaluation.

4. The method as recited in claim 1, wherein the training at each edge node is performed with real data that is local to that edge node.

5. The method as recited in claim 1, wherein the training is performed without any exchange of local data between the edge nodes.

6. The method as recited in claim 1, wherein the search-iteration process selects top fitness individuals and a random sample of individuals for inclusion in the next generation.

7. The method as recited in claim 6, wherein the top fitness individuals are identified according to their respective fitness scores.

8. The method as recited in claim 1, wherein the search-iteration process comprises generating new individuals for the next generation.

9. The method as recited in claim 8, wherein the new individuals are generated based on the individuals in the initial generation.

10. The method as recited in claim 8, wherein the new individuals are generated using new prune masks that include portions of the random prune masks that were used to generate the individuals in the initial generation.

11. The method as recited in claim 1, wherein the halting condition is met when ‘m’ generations of individuals have been generated without an improvement in best fitness of a best scoring individual.

12. A non-transitory storage medium having stored therein instructions that are executable by one or more hardware processors to:
in an environment comprising edge nodes and a central node configured to communication with the edge nodes, performing operations comprising:
causing one or more of the edge nodes to generate and train an initial full candidate machine learning (ML) model, and the training of the initial full candidate ML models is performed only once at the one or more edge nodes;
at the central node, applying a respective random prune mask to each of the initial full candidate ML models so as to generate a respective pruned model, and each of the pruned models comprises an individual in an initial generation;
computing a fitness score for each of the individuals based on a generalization loss and on a number of pruned parameters in the model; and
when a halting condition is not met, performing a search-iteration process to create a next generation of individuals or, alternatively, when the halting condition is met, deploying a pruned model of a best scoring individual to one or more target edge nodes.

13. The non-transitory storage medium as recited in claim 12, wherein the training at each edge node is performed with real data that is local to that edge node.

14. The non-transitory storage medium as recited in claim 12, wherein the training is performed without any exchange of local data between the edge nodes.

15. The non-transitory storage medium as recited in claim 12, wherein the search-iteration process selects top fitness individuals and a random sample of individuals for inclusion in the next generation.

16. The non-transitory storage medium as recited in claim 14, wherein the top fitness individuals are identified according to their respective fitness scores.

17. The non-transitory storage medium as recited in claim 12, wherein the search-iteration process comprises generating new individuals for the next generation.

18. The non-transitory storage medium as recited in claim 16, wherein the new individuals are generated based on the individuals in the initial generation.

19. The non-transitory storage medium as recited in claim 16, wherein the new individuals are generated using new prune masks that include portions of the random prune masks that were used to generate the individuals in the initial generation.

20. The non-transitory storage medium as recited in claim 12, wherein the halting condition is met when ‘m’ generations of individuals have been generated without an improvement in best fitness of a best scoring individual.
